(19) United States
(12) Patent Application Publication
(10) Pub. No.: US 2022/0087484 A1
(43) Pub. Date: Mar. 24, 2022

(54) SANITIZATION DISPENSER

(71) Applicant: Miles Pepper, Sebastopol, CA (US)

(72) Inventor: Miles Pepper, Sebastopol, CA (US)

(21) Appl. No.: 17/027,530

(22) Filed: Sep. 21, 2020

(51) Int. Cl. A47K 5/12; B05B 11/00

(52) U.S. Cl. CPC A47K 5/1201; B05B 11/0027

(57) ABSTRACT

The present invention relates to a sanitization dispenser having a base container and a cover member adjoined thereto. Within the cover member a pump assembly is arranged to displace a liquid and/or sanitizer from the reservoir, through the pump assembly, into the cavity and out an orifice of a spray tip. The pump assembly further includes a positive transfer pump having a biasing member, and a transfer tube. After the user depresses the button member to a depressed position, the biasing member returns the button member to a resting position. In some embodiments, sanitization dispenser includes the at least one button protrusion extending outward from the perimeter edge of the button member and at least one guide slot extending into the cover member. The at least one button protrusion limits the rotation of the button member within the cover member and allows for easy operation by the user when depressing the button member. Through this operation described above a spray or mist of liquid and/or sanitizer is disbursed.

### BACKGROUND

### 1. Field of the Invention

The present invention relates to a sanitization dispenser for controlled dispersion of sanitizer and/or other liquid.

### 2. Description of Related Art

Pump and spray dispensers for liquids and hand sanitizers with high viscosities are commonly used for a myriad of household products. Sanitization for items, extremities and surfaces is a common and outstanding concern for many humans. Common practice can typically involve spraying a liquid onto an item, extremities or surface and sequentially whipping that surface with a cloth or towel.

Some of the most common sanitizer dispensers include pumps that a consumer manually engages downward to either spray or dispenser a liquid and/or gel as desired. Other sanitizers are commonly dispensed through handle pump sprayers, wherein radial engagement of the pump handle translates into liquid and/or sanitizer being forced through an orifice to produce a spray.

Issues arise in common use when convivence, ease of use and accessibility are addressed. With common cleaning practices the consumer must not only carry around a traditional spray bottle, but also a cloth member or fabric towel to finish sanitizing items, extremities or surfaces. Cloth members, paper towels and fabric towels often can because contaminated with unwanted substances after multiple cycles of use by the user. Furthermore, the use of a cloth member or towel is often conducted to uniformly distribute a sanitizer or cleaner upon an item, extremities or surface due to non-uniform spray.

Second, transportation of a dispenser such as a handle pump sprayer and accompanying cloth or towel is cumbersome. Handles or levers of such sprayers are not made for compact storage within other articles such as a purse, handbag or backpack. The consumer must also tote the cloth or towel and remember to interchange the cloth or towel regularly. An improved design is needed that allows for compact storage without accidental discharge.

The need for a cloth and/or towel could also be mitigated with proper disbursement of a liquid or sanitizer from the dispenser, eliminating the need for sub sequentially wiping or spreading by a cloth or towel.

Wet or moist wipes that are pre-packaged are also wasteful after multiple cycles of cleaning or sanitizing the same surface. Gels and other sanitizers can be useful in sanitizing a user's hands, but often fall short in sanitizing items and hard surfaces. An improved design for controlled and uniform disbursement of a sanitizer on a surface is needed.

Lastly, many gel sanitizer containers, spray bottles and wet wipes do not come with an option for refillable cartridges, containers or inserts. This is logical in a consumer market where consumption causes the consumer to re-purchase the item, but many consumers now desire reusable items with minimal ecological impact. A solution is needed for simply re-filling interchangeable reservoirs within articles that spray a liquid and/or sanitizer.

### SUMMARY

The present invention relates to a sanitization dispenser comprising of a compact and ergonomic design that is easily stored in compact spaces, such as a pocket of a clothing article, belt or or a purse. Secondly, the sanitization dispenser allows the user to easily refill a reservoir as desired. A cover member also guards a button member from depression during storage in compact spaces or during transport by the user.

Another unique feature of the present invention includes the design of the cover member relative to the base container of the sanitization dispenser, allowing for custom configuration by the user. For example, the base container may be interchanged as different attachment member are needed by the user to adjoin the sanitization dispenser to an article or a surface.

Another goal of the present invention is to provide a spray tip that is interchangeable, allowing the user to adapt the sanitization dispenser as desired to sanitize different items, extremities or surfaces.

In order to do so, a sanitization dispenser is provided having a base container and a cover member adjoined thereto. Within the cover member a pump assembly is arranged to displace a liquid and/or sanitizer from the reservoir, through the pump assembly, into the cavity and out an orifice of a spray tip. The pump assembly further includes a positive transfer pump having a biasing member, and a transfer tube. After the user depresses the button member to a depressed position, the biasing member returns the button member to a resting position. In some embodiments, the sanitization dispenser includes at least one button protrusion extending outward from the perimeter edge of the button member and at least one guide slot extending into the cover member. The at least one button protrusion limits the rotation of the button member within the cover member and allows for easy operation by the user when depressing the button member. Through this operation a spray or mist of liquid and/or sanitizer is disbursed.

### BRIEF DESCRIPTION OF THE FIGURES

The detailed description of some embodiments of the invention is made below with reference to the accompanying figures, wherein like numerals represent corresponding parts of the figures.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary perspective view of one embodiment of the sanitization dispenser.

FIG. 2 shows an exemplary exploded view of one embodiment of the sanitization dispenser.

FIG. 3 shows an exemplary front view of one embodiment of the sanitization dispenser.

FIG. 4 shows an exemplary sectional view of one embodiment of the sanitization dispenser taken along parting line 4-4 of FIG. 3.

FIG. 5A shows an exemplary right view of one embodiment of sanitization dispenser.

FIG. 5B shows an exemplary right view of one embodiment of the sanitization dispenser.

FIG. 5C shows an exemplary right view of one embodiment of the sanitization dispenser.

FIG. 6A shows an exemplary perspective view of one embodiment of the spray tip of the sanitization dispenser.

FIG. 6B shows an exemplary right view of one embodiment of the cover member of the sanitization dispenser.

FIG. 6C shows an exemplary front view of one embodiment of the cover member of the sanitization dispenser.

FIG. 7A shows an exemplary top view of one embodiment of the button member of the sanitization dispenser.

FIG. 7B shows an exemplary bottom view of one embodiment of the button member of the sanitization dispenser.

FIG. 8 shows an exemplary right view of one embodiment of the pump assembly of the sanitization dispenser.

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

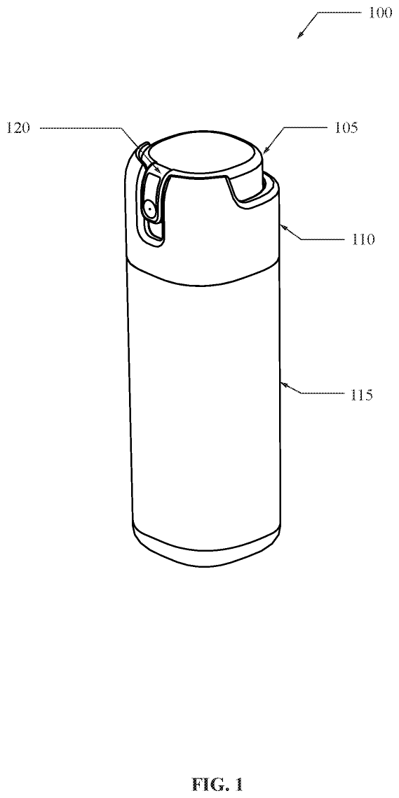

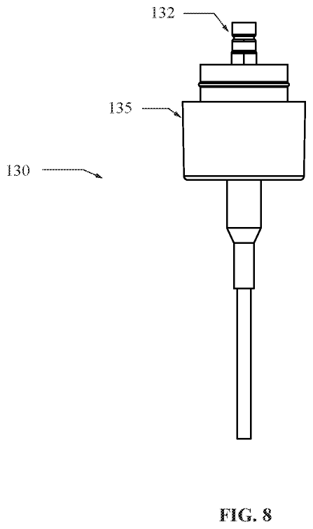

FIG. 1 illustrates a sanitization dispenser 100 for a controlled disbursement of a liquid 150 and/or sanitizer. A base container 115 is adjoined to a cover member 110. The cover member 110 housing a pump assembly 130 within. The base container 115 having a first opening 117 protruding into the base container 115 and is configured to hold a reservoir 140 within. The size and shape of the reservoir 140, without limitation, adapted to fit within the base container 115. In some embodiments, the base container 115 is removable and interchange based on the needs of the user. A button member 105 is housed within the cover member 110 and is sized and shaped to substantially match the cover member. In other embodiments, the button member 105 may include protrusions that limit the button member 105 from protruding above the cover member 110. The cover member 110 next having a pump assembly 130 within, as further illustrated in FIG. 8. In some embodiments, a portion of the cover member 110 may be removed or shaped for ease of access to the button member 105 or to form a retention finger 113 aiding to guard and retain the button member 105 within the cover member 110.

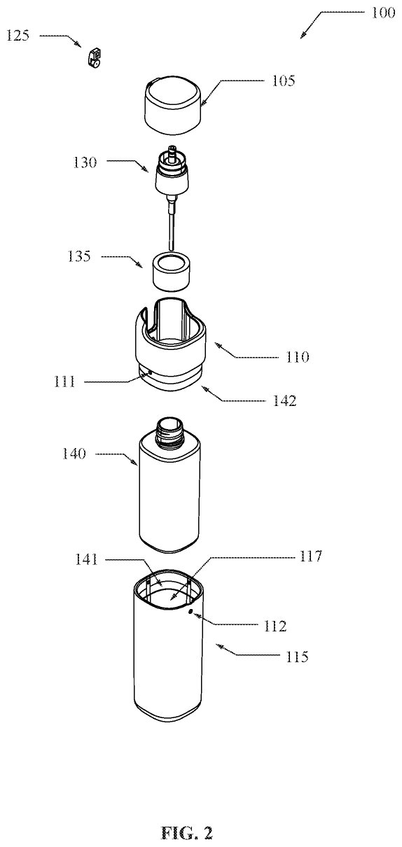

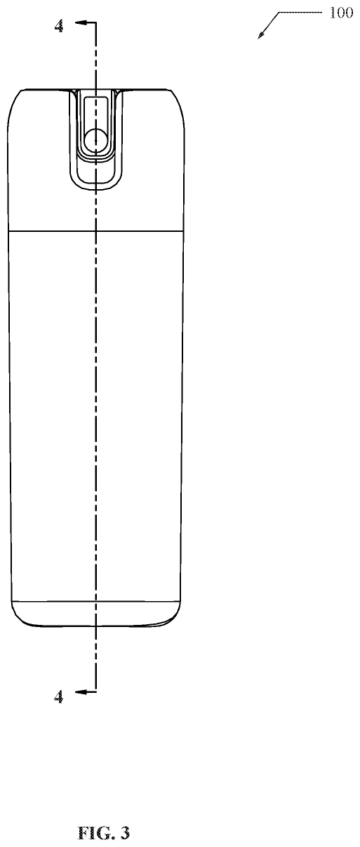

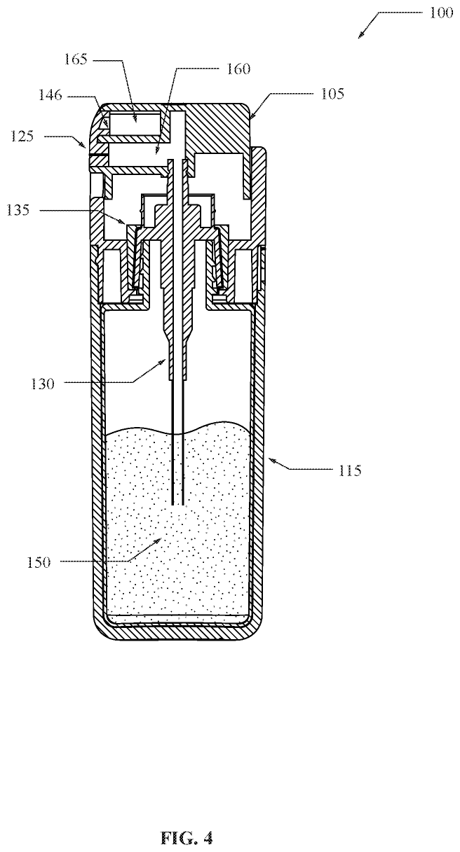

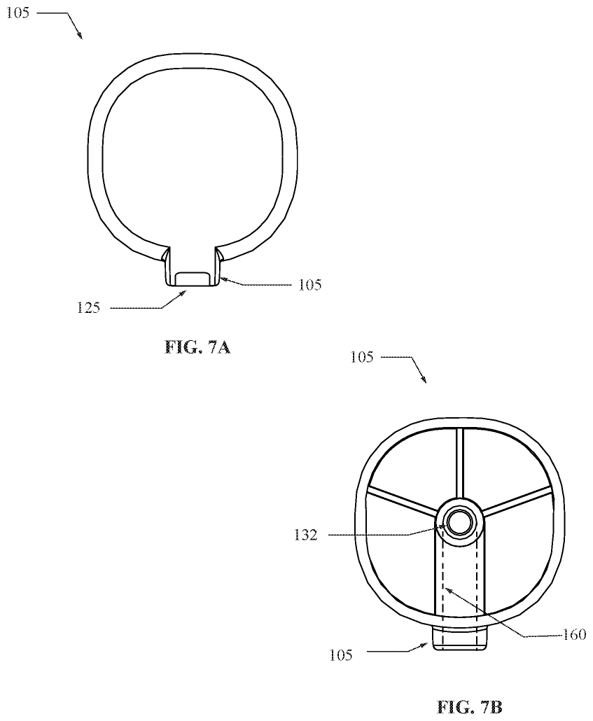

As shown in FIGS. 2, 3 and 4 the sanitization dispenser 100 is illustrated in a cross-sectional and an exploded view. During exemplary assembly, a spray tip 125 is inserted within the cavity 160 of the button member. In the current exemplary embodiment, the cavity 160 protrudes through the button member 105 from a perimeter edge of the button member 105 to the bottom surface of the button member, as seen in FIGS. 7A and 7B. The cavity 160 is next adapted to receive a portion of the pump assembly 130 or a proximal end of the transfer tube 133. In other embodiments, the reservoir 140 may be adjoined to the pump assembly 130 and/or the pump assembly 130 may be adjoined to the button member 105 by one or more attachment member 116 of an attachment set consisting of: a magnet, a clip, a tab, a slot, a rail, a joint, a heat-shrink material flange, a slide-fit, a clamp, a spring, an elastic member, a snap-fit, a fastener, an elastic member, an adhesive or any combination thereof.

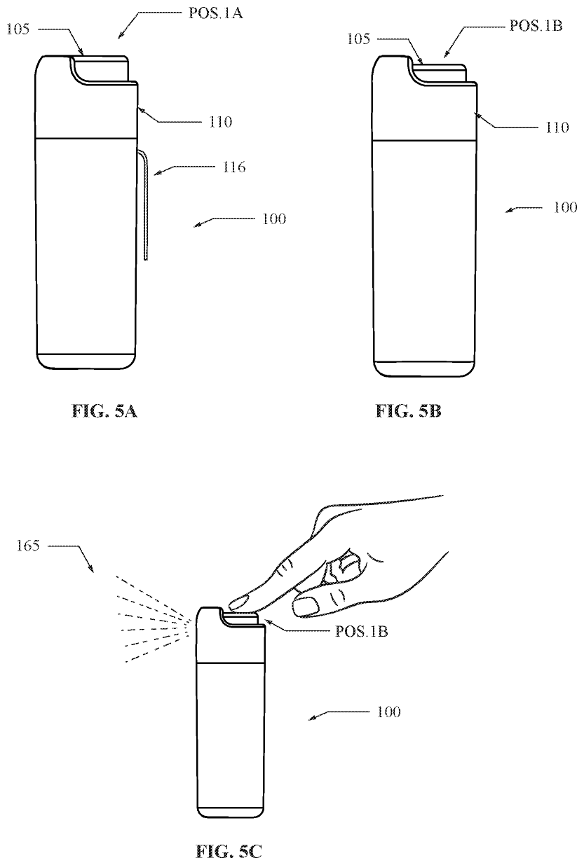

In exemplary operation, as shown in FIGS. 5A, 5B and 5C the user may depress the button member 105 from a resting position POS.1A to a depressed position POS.1B, in doing so the user engages a positive transfer pump 132 to move a liquid 150 from the reservoir 140 into the transfer tube 133 of the pump assembly 130 and into the cavity 160 of the button member 105. Next, as the button member 105 is repetitively cycled from POS. 1A to POS.1B pressure is altered within the cavity 160 forcing air and/or the liquid 150 through the orifice 147 of the spray tip 125. The pump assembly 130 may also include a biasing member, such as a spring or an elastic member to return the button member 105 to POS.1A. In other embodiments, the pump assembly 130 may include a collar member 135 surrounding the positive transfer pump 132 and aiding in alignment of the pump assembly 130 within the cover member 110. In some embodiments, the collar member 135 is made of a non-rigid material. The reservoir 140 is then removably adjoined to the pump assembly 130. The adjoining of the reservoir 140 to the pump assembly 130, in the present embodiment shown in FIG. 2 is accomplished by a threaded connection. In other embodiments, the pump assembly 130 may be interchanged with other common pump types known to one skilled in the art, such as trigger pumps.

In some embodiments, the pump assembly 130 further comprises at least one member of a valve set and/or a check valve. A check valve may be used in line with the transfer tube 133 of the pump assembly 130 to regulate direction flow of air and/or the liquid 150 from the reservoir 140 to the cavity 160. The desired direction in the current embodiment of the sanitization dispenser 100 is from the reservoir 140 to the cavity 160. The check valve may also be interchanged with a clack valve, a non-return valve, a reflux valve, a retention valve or a one-way valve is a valve that normally allows fluid (liquid 150 or gas) to flow through it in only one direction. In further description, the pump assembly 130 may include at least one member of a valve set consisting of: a pressure control valve, a flow control valve, and a directional control valves, a directly operated valve, a pilot operated valve, a manually operated valve, an electrically actuated valve, an open control valve, a servo controlled valve, and a manifold.

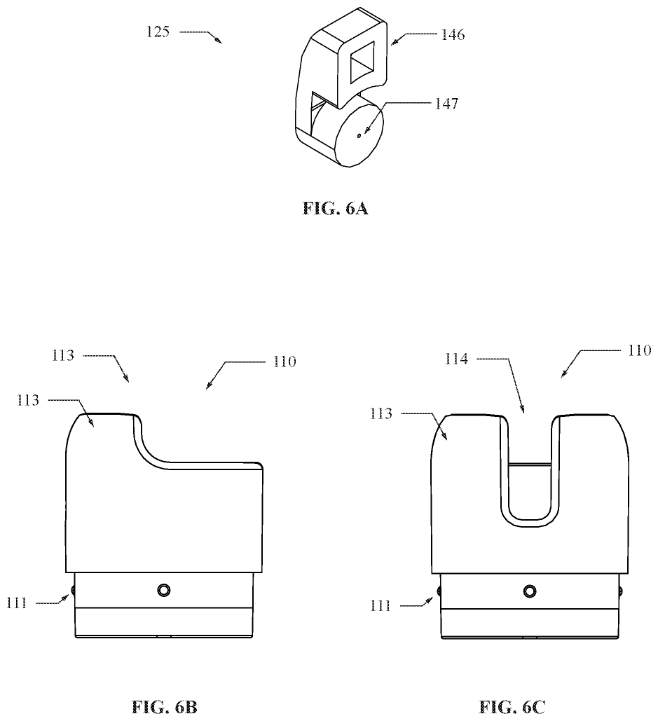

As shown in FIG. 6A, in some embodiments the spray tip 125 further comprises a first tip protrusion 146 and a second tip protrusion 148. In some embodiments, the orifice 147 may be constructed as, without limitation, a shaped orifice having at least one side, a circular orifice, or a tapered orifice. In other embodiment, the spray tip 125 may include at least one orifice 147. The orifice 147 of the spray tip 125 therein allows for a spray, mist or steam of sanitizer to be disbursed from the sanitization dispenser 100. By non-limiting example, the orifice 147 and/or spray tip 125 may be selected by the user for spray, jet, mist, stream, continuous or foaming disbursement of the liquid within the reservoir 140. The current invention is in no way limited by the liquid 150 held within the reservoir 140, for example one skilled in the art will recognize many different liquids and agents that could be used in conjunction with the present invention such as: cannabis products or derivatives, industrial hemp products or derivatives, edible products, alcoholic beverages, sanitizers, oven cleaners, upholstery cleaners, alloy wheel cleaning solutions, car wax applications, barbeque cleaners, frying oil, bathroom sink, bath cleaners, toilet cleaners, massage oils, pain relief gels, hair gels, hair sprays, floor cleaners, window cleaners, garden products, shower cleaners, stain removers, surface cleaners, wood surface enhancers, air fresheners, multi-purpose products, mold removers, degreasers, limescale removers and shine, grout cleaners, clothes fresheners, all in one products, paint repair solutions, natural & organic scents or cleaners, hand soaps, face cleansers, suntan lotions, moisturizers, metal restorers and/or other liquids known to one skilled in the art of sanitation and cleaning.

As shown in FIGS. 6B and 6C the cover member 110 may further comprise a plurality of protrusions 111 arranged upon the cover member 110 and a plurality of indentations 112 arranged within the first opening 117 of the base container 115. During exemplary assembly, the user adjoins the cover member 110 to the base container 115 by aligning the plurality of protrusions 111 to the plurality of indentations 112. In another embodiment, not illustrated, the cover member 110 comprises the plurality of indentations 112 and the base member comprises the plurality of protrusions 111. In yet another embodiment, the cover member 110 and the base member are adjoined by one or more attachment member 116 of the attachment set. In other configurations of the sanitization dispenser 100 alignment of the cover member 110 and the base container 115 is further aided by at least one slot 141 extending into the first opening 117 the base container 115 and at least one tab 142 protruding outward from the cover member 110. Wherein during assembly or configuration the at least one slot 141 is configured to receive the at least one tab 142. The slot 141 and the tab 142 aiding in alignment of the base container 115 relative to the cover member 110. In yet another embodiment, inversely the cover member 110 may comprise the at least one slot 141 and the base container 115 may comprise the at least one tab 142.

As shown in FIGS. 7A & 7B, to further aid in the operation of the sanitization dispenser 100 the button member 105 may further comprise at least one button protrusion 120 extending outward from the perimeter edge of the button member 105. As shown in FIGS. 6A & 6B, at least one guide slot 114 extending into the cover member 110 is adapted to receive the at least one button protrusion 120. During cycling of button member 105 from POS.1A to POS.1B, the rotation of the button member 105 within the cover member 110 is limited by the at least one button protrusion 120 within the at least one guide slot 114, therein allowing for a consistent direction of sanitization by the sanitization dispenser 100.

Next, a tip indentation 165 extends into the button member 105 and is shaped to receive the first tip protrusion 146. During assembly or changing of the spray tip 125, the first tip protrusion 146 is aligned with the tip indentation 165 and the second tip protrusion is aligned during assembly with the cavity 160. The alignment of the first tip protrusion 146 and the second tip protrusion 148 further aid the user in proper orientation of the orifice 147 relative to the cavity 160. For example, in embodiments having a non-circular orifice 147 the alignment of the first tip protrusion 146 to the tip indentation 165 can ensure disbursement of the liquid 150 in a desired shape, angle or direction.

During one-handed operation of the sanitization dispenser 100 by the user an external texture in some embodiments may aid in controlled depression of the button member 105 within the cover member 110. Without limitation, the button member, the cover member 110 and/or the base container 115 may further comprise an external texture. The external texture further comprises at least one member of a texture set consisting of: indentations, extrusions, knurling, a rough surface, and bumps. Without limitation, the button member, the reservoir 140, the cover member 110 and/or the base container 115 may further comprise at least one member of an identification set consisting of: an alphanumeric identification, a human user's name, a symbolic shape, a company brand, a numeric identification number, a QR code, a barcode, and an RFID tag.

In reference to FIGS. 1-8, the present invention may include the following elements:
a sanitization dispenser 100
a button member 105
a cover member 110
a plurality of protrusions 111
a plurality of indentations 112
a retention finger 113
a guide slot 114
a base container 115
an attachment member 116
a first opening 117
a button protrusion 120
a spray tip 125
a pump assembly 130
a positive transfer pump 132
a transfer tube 133
a collar member 135
a reservoir 140
a slot 141
a tab 142
a first tip protrusion 146
an orifice 147
a second tip protrusion 148
a liquid 150
a cavity 160
a tip indentation 165

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 0%, 5%, or 10%, including increments therein.

Unless otherwise defined, all technical terms used herein have the same meaning as commonly understood by one of ordinary skill in the art to which this disclosure belongs.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶ 6. In particular, any use of “step of” in the claims is not intended to invoke the provision of 35 U.S.C. § 112, ¶ 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A sanitization dispenser, for a controlled disbursement of a liquid, the sanitization dispenser comprising:
a base container having a first opening protruding into the base container;
a reservoir arranged within the first opening of the base container having the liquid stored within;
a cover member removably adjoined to the first opening;
a button member having a perimeter edge, a top surface and a bottom surface;
a cavity within the button member having an internal volume;
a spray tip arranged within the cavity and having an orifice;
a pump assembly arranged within the cover member and adjoined to the reservoir comprising:
a positive transfer pump having a biasing member;
a transfer tube having a proximal end and a distal end; and
wherein the proximal end of the transfer tube is adjoined to the cavity and the distal end of the transfer tube is arranged within the reservoir;
wherein in a first mode of operation a user presses the button member to engage the positive transfer pump, therein altering a pressure within the cavity and dispersing the liquid through the orifice of the spray tip; and
wherein in a second mode of operation the biasing member returns the button member to a resting position.

2. The sanitization dispenser of claim 1, further comprising:
at least one button protrusion extending outward from the perimeter edge of the button member;
at least one guide slot extending into the cover member and adapted to receive the at least one button protrusion; and
wherein the first mode of operation a rotation of the button member within the cover member is limited by the at least one button protrusion within the at least one guide slot.

3. The sanitization dispenser of claim 1, wherein the spray tip further comprises:
a first tip protrusion extending outward from the spray tip;
a second tip protrusion extending outward from the spray tip;
a tip indentation extending into the button member; and
wherein the first tip protrusion is aligned during assembly with the tip indentation and the second tip protrusion is aligned during assembly with the cavity.

4. The sanitization dispenser of claim 1, wherein the base container is interchangeable by the user without disassembly of the reservoir and the pump assembly.

5. The sanitization dispenser of claim 1, wherein the base container further comprises at least one attachment member an attachment set consisting of: a magnet, a clip, a tab, a slot, a rail, a joint, a heat-shrink material flange, a slide-fit, a clamp, a spring, an elastic member, a snap-fit, a fastener, an elastic member, an adhesive or any combination thereof.

6. The sanitization dispenser of claim 1, wherein the positive transfer pump further comprises:
a collar member surrounding the positive transfer pump and aiding in alignment of the pump assembly within the cover member.

7. The sanitization dispenser of claim 6, wherein the collar member is made of a non-rigid material.

8. The sanitization dispenser of claim 1, wherein the sanitization dispenser further comprises:
a plurality of protrusions arranged within the first opening of the base container;
a plurality of indentations arranged upon the cover member; and
wherein a third mode of operation the user adjoins the cover member to the base container by aligning the plurality of protrusions to the plurality of indentations.

9. The sanitization dispenser of claim 1, wherein the sanitization dispenser further comprises:
a plurality of protrusions arranged upon the cover member;
a plurality of indentations arranged within the first opening of the base container; and
wherein a third mode of operation the user adjoins the cover member to the base container by aligning the plurality of protrusions to the plurality of indentations.

10. The sanitization dispenser of claim 1, wherein the sanitization dispenser further comprises:
at least one slot extending into the first opening the base container;
at least one tab protruding outward from the cover member and configured to receive the at least one slot; and
wherein a fourth mode of operation alignment by the user of the at least one tab and the at least one slot provides proper alignment of the base container relative to the cover member.

11. The sanitization dispenser of claim 1, wherein the sanitization dispenser further comprises:
at least one slot extending into the cover member;
at least one tab protruding outward from the first opening of the base container and configured to receive the at least one slot; and
wherein a fourth mode of operation alignment by the user of the at least one tab and the at least one slot provides proper alignment of the base container relative to the cover member.

12. The sanitization dispenser of claim 1, wherein the button member, the cover member and/or the base container further comprise an external texture.

13. The sanitization dispenser of claim 12, wherein the external texture further comprises at least one member of a texture set consisting of: indentations, extrusions, knurling, a rough surface, and bumps.

14. The sanitization dispenser of claim 1, wherein the sanitization dispenser further comprises at least one member of an identification set consisting of: an alphanumeric identification, a human user's name, a symbolic shape, a company brand, a numeric identification number, a QR code, a barcode, and an RFID tag.

15. The sanitization dispenser of claim 1, wherein the pump assembly further comprises a check valve allowing only for transfer of the liquid from the reservoir to the cavity.

16. The sanitization dispenser of claim 1, wherein the pump assembly further comprises at least one member of a valve set.

17. The sanitization dispenser of claim 1, wherein the spray tip is interchangeable by the user to alter the controlled disbursement of the liquid from the sanitization dispenser.
